(19) United States
(12) Patent Application Publication
(10) Pub. No.: US 2026/0212282 A1
(43) Pub. Date: Jul. 23, 2026

(54) METHOD, APPARATUS, DEVICE, AND MEDIUM FOR MANAGING MACHINE LEARNING MODEL BASED ON DISTILLATION

(71) Applicants: Beijing Zitiao Network Technology Co., Ltd., Beijing (CN); Lemon Inc., Grand Cayman (KY)

(72) Inventors: Peiyi Li, Beijing (CN); Xin Fang, Beijing (CN); Chenghui Yu, Beijing (CN); Haoze Wu, Beijing (CN); Hongyu Xiong, Los Angeles, CA (US); Guangmou Pan, Beijing (CN); Bingfeng Deng, Beijing (CN)

(21) Appl. No.: 19/454,217

(22) Filed: Jan. 20, 2026

(30) Foreign Application Priority Data
Jan. 21, 2025 (WO) PCT/CN2025/073776

(51) Int. Cl. G06N 20/20

(52) U.S. Cl. CPC G06N 20/20

(57) ABSTRACT

A method, a device, and a medium for managing a machine learning model based on distillation are provided. A first machine learning model is determined using a first reference sample associated with a first reference object in an application, the first reference sample including a first reference classification specified by a first reference object for a first reference media item. A prediction of a second reference classification by a second reference object in the application for the second reference media item is determined using the first machine learning model. A second reference sample is generated based on the second reference object, the second reference media item, and the prediction of the second reference classification. A second machine learning model is determined using the second reference sample, the second machine learning model describing an association between an object in the application and a classification by the object for the media item.

### CROSS REFERENCE

This application claims priority to PCT Application No. PCT/CN2025/073776, filed on Jan. 21, 2025, and entitled “METHOD, APPARATUS, DEVICE, AND MEDIUM FOR MANAGING MACHINE LEARNING MODEL BASED ON DISTILLATION”, the entirety of which is incorporated herein by reference.

### FIELD

Implementations of the disclosure generally relate to the field of computers, and in particular, to a method, an apparatus, a device, and a computer-readable storage medium for managing a machine learning model based on distillation.

### BACKGROUND

Machine learning techniques have been widely used to perform a variety of tasks. For example, in a recommendation scenario, various media items may be recommended to objects in an application by using a machine learning model (for example, a recommendation model). To improve the accuracy of the recommendation, questions may be provided to the object in order to ask if the recommended media item is liked. However, excessive problems may impact the normal use of the application, which results in a small number of samples collected, and it is difficult to use these sparse samples to update the machine learning model. At this time, it is expected to solve the problem of insufficient sample quantity, and update the machine learning model in a more accurate manner.

### SUMMARY

In a first aspect of the disclosure, a method for managing a machine learning model is provided. In the method, a first machine learning model is determined using a first reference sample associated with a first reference object in an application, the first reference sample including a first reference classification specified by a first reference object for a first reference media item, the first machine learning model describing an association relationship between a first object provided with the first media item and a first classification by the first object for the first media item. A prediction of a second reference classification by a second reference object in the application for the second reference media item is determined using the first machine learning model. A second reference sample is generated based on the second reference object, the second reference media item, and the prediction of the second reference classification. A second machine learning model is determined using the second reference sample, the second machine learning model describing an association between an object in the application and a classification by the object for the media item.

In a second aspect of the disclosure, an apparatus for managing a machine learning model is provided. The apparatus includes: a first determination module configured to determine a first machine learning model using a first reference sample associated with a first reference object in an application, the first reference sample including a first reference classification specified by the first reference object for a first reference media item, the first machine learning model describing an association relationship between a first object provided with the first media item and a first classification by the first object for the first media item; a prediction module configured to determine a prediction of a second reference classification by a second reference object in the application for a second reference media item using the first machine learning model; a generation module configured to generate a second reference sample based on the second reference object, the second reference media item, and the prediction of the second reference classification; and a second determination module configured to determine a second machine learning model using the second reference sample, the second machine learning model describing an association relationship between an object in the application and a classification by the object for a media item.

In a third aspect of the disclosure, an electronic device is provided. The electronic device includes: at least one processor; and at least one memory coupled to the at least one processor and storing instructions for execution by the at least one processor, the instructions, when executed by the at least one processor, causing the electronic device to perform the method according to the first aspect of the disclosure.

In a fourth aspect of the disclosure, there is provided a non-transitory computer-readable storage medium having stored thereon a computer program which, when executed by a processor, causes the processor to implement the method according to the first aspect of the disclosure.

In a fifth aspect of the disclosure, there is provided a computer program product, including a computer program, wherein the computer program, when executed by a processor, implements the method according to the first aspect of the disclosure.

It should be understood that the contents described in this disclosure are not intended to limit key features or major features of implementations of the disclosure, nor is it intended to limit the scope of the disclosure. Other features of the disclosure will become readily understood from the following description.

### BRIEF DESCRIPTION OF DRAWINGS

The above and other features, advantages, and aspects of various implementations of the disclosure will become more apparent from the following detailed description taken in conjunction with the accompanying drawings. In the drawings, the same or similar reference numbers refer to the same or similar elements, wherein:

FIG. 1 shows a block diagram of an application environment according to an implementation of the disclosure;

FIG. 2 shows a block diagram for managing a machine learning model according to some implementations of the disclosure;

FIG. 3A shows a block diagram of a structure of a feature space of a first machine learning model according to some implementations of the disclosure;

FIG. 3B shows a block diagram of a structure of a feature space of a second machine learning model according to some implementations of the disclosure;

FIG. 4 shows a block diagram of a structure of a machine learning model according to some implementations of the disclosure;

FIG. 5 shows a block diagram of a process for managing a machine learning model based on distillation according to some implementations of the disclosure;

FIG. 6 shows a flowchart of a method for managing a machine learning model according to some implementations of the disclosure;

FIG. 7 shows a block diagram of an apparatus for managing a machine learning model according to some implementations of the disclosure; and

FIG. 8 shows a block diagram of a device capable of implementing various implementations of the disclosure.

### DETAILED DESCRIPTION

Implementations of the disclosure will be described in more detail below with reference to the accompanying drawings. While certain implementations of the disclosure are shown in the accompanying drawings, it should be understood that the disclosure may be implemented in various forms and should not be construed as limitation to the implementations set forth herein, but rather, these implementations are provided for a more thorough and complete understanding of the disclosure. It should be understood that the drawings and implementations of the disclosure are for illustrative purposes only and are not intended to limit the scope of the disclosure.

In the description of implementations of the disclosure, the term “include” and similar terms should be understood as open-ended inclusion, i.e., “including but not limited to”. The term “based on” should be understood as “based at least in part on”. The terms “an implementation” or “the implementation” should be understood as “at least one implementation”. The term “some implementations” should be understood as “at least some implementations”. Other explicit and implicit definitions may also be included below. As used herein, the term “model” may represent an association relationship between various data. For example, the association relationship may be obtained based on various technical solutions currently known and/or to be developed in the future.

It may be understood that the data involved in the technical solution (including but not limited to the data itself, the acquisition or use of the data) should follow the requirements of the corresponding laws and regulations and related regulations.

It can be understood that, before the technical solutions disclosed in the embodiments of the disclosure are used, the types of personal information related to the disclosure, the usage scope, the usage scenario and the like should be notified to the user in an appropriate manner according to the relevant laws and regulations, and the authorization therefor should be obtained from the user.

For example, in response to receiving an active request from a user, prompt information is sent to the user to explicitly prompt the user that the requested operation will need to acquire and use the personal information of the user. Therefore, the user can autonomously select whether to provide personal information to software or hardware such as an electronic device, an application, a server and a storage medium executing the operation of the technical solution of the disclosure according to the prompt information.

As an optional but non-limiting implementation, in response to receiving an active request of the user, a manner of sending prompt information to the user may be, for example, a manner of a pop-up window, and prompt information may be presented in a text manner in the pop-up window. In addition, the pop-up window may further carry a selection control for the user to select “agree” or “not agree” to provide personal information to the electronic device.

It may be understood that the foregoing notification and a process for obtaining a user authorization is merely illustrative, and does not constitute a limitation on implementations of the disclosure, and other manners of meeting related laws and regulations may also be applied to implementations of the disclosure.

The term “in response to” as used herein means a state in which a respective event occurs or condition is satisfied. It will be appreciated that the timing of execution of a subsequent action performed in response to the event or condition is not necessarily strongly correlated with the time at which the event occurs or the condition is established. For example, in some cases, subsequent actions may be performed immediately when an event occurs or a condition is established; while in other cases, subsequent actions may be performed after a period of time elapses after an event occurs or a condition is established.

### Example Environment

Machine learning techniques have been widely used to perform a variety of tasks. For example, in a recommendation scenario, various media items may be recommended to objects in an application by using a machine learning model (for example, a recommendation model). FIG. 1 is a block diagram 100 of an application environment according to some implementations of the disclosure. As shown in FIG. 1, a media item 120 may be provided to an object in an application 110 (e.g., a user of the application 110), and the media item 120 may include multiple types, including, but not limited to, video, short video, music, text, images, games, or rich media data including combinations of the above multiple types. For ease of description, the video is described as an example of the media item in the context of the disclosure.

To improve the accuracy of the recommendation, questions may be provided to the object through a questionnaire, for example, the object may be asked to annotate and classify the recommended media item, and it may be inquired whether the object likes the recommended media item, and the like. A questionnaire page 130 may be provided in the application 110, for example, the questions may be presented to various objects of the application 110 (e.g., inquiring a classification of a browsed media item) and a response for the question from the object may be received.

The page 130 may include a control 138 for refusing to submit the response, and may cancel the page in response to receiving an interaction request with the control 138. The page 130 may further include a control 136 for submitting the response, and may include one or more predetermined classifications. For example, a control 132 corresponds to “classification 1”, . . . , a control 134 corresponds to “classification N”. The object may select the desired classification and press a control 136 to submit the selected classification. The response from the object may be collected, and the response is used to learn an association relationship between the object and the media item, thereby improving the accuracy of recommendation.

However, excessive questionnaires may affect normal use of the application, which results in a smaller number of samples collected, and it is difficult to use these sparse samples to update the machine learning model. At this time, it is expected to solve the problem of insufficient sample quantity, and update the machine learning model in a more accurate manner.

### Summary of Distillation Process

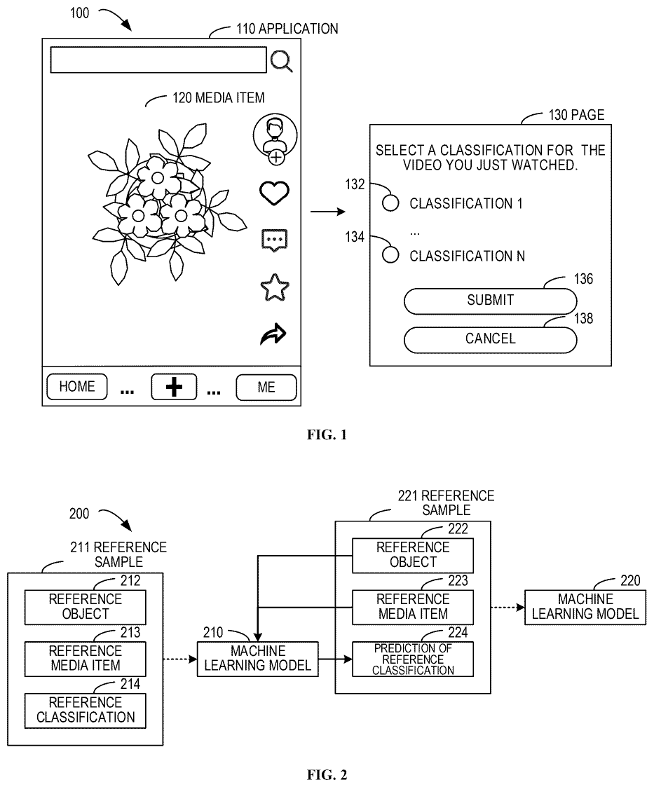

In order to at least partially solve the deficiencies in the prior art, according to an implementation of the disclosure, a method for managing a machine learning model is provided. Referring to FIG. 2, a summary is described according to an implementation of the disclosure, and FIG. 2 shows a block diagram 200 for managing a machine learning model according to some implementations of the disclosure. As shown in FIG. 2, the machine learning model 210 may be trained using collected sparse samples (e.g., reference samples 211, etc.) and more samples (e.g., reference samples 221, etc.) may be generated using the machine learning model 210 to update the machine learning model 220.

Specifically, a first machine learning model (e.g., the machine learning model 210) may be determined using a first reference sample (e.g., the reference sample 211) associated with a first reference object in the application. The first reference sample may include a first reference classification (e.g., a reference classification 214) specified by the first reference object (e.g., a reference object 212) for a first reference media item (e.g., a reference media item 213). Here, the first machine learning model describes an association relationship between a first object provided with a first media item and a first classification submitted by the first object for the first media item. In other words, the questionnaire may be provided to a small number of objects in the application and the classification may be collected, and a small number of samples may be utilized to train the machine learning model 210.

A prediction of a second reference classification (e.g., a prediction 224 of the reference classification) submitted by a second reference object (e.g., a reference object 222) in the application for a second reference media item (e.g., the reference media item) may be determined using the trained first machine learning model. A second reference sample (e.g., the reference sample 221) is generated based on the second reference object, the second reference media item, and the prediction of the second reference classification. At this point, the prediction of the second reference classification is a soft label, although it is not real truth data, the prediction is generated by the trained machine learning model 210, so that the accuracy of the prediction 224 of the reference classification is high, and may be used as training data. Further, the second machine learning model (e.g., the machine learning model 220) may be determined using the second reference sample. At this time, the second machine learning model may describe an association relationship between the object in the application and the classification by the object for the media item.

With some implementations of the disclosure, a small number of reference samples may be obtained with minimal interference or without interference on the usage of application. In this way, more reference samples may be obtained from the sparse reference samples, and the accuracy of the machine learning model is improved while reducing the interference on the normal use of the application.

### Detailed Process of Distillation Process

Having described a summary according to some implementations of the disclosure, more details regarding a method for managing a machine learning model will be described below. According to some implementations of the disclosure, the machine learning model 210 may be trained using historical data. For example, the first reference sample (the reference sample is also referred to as a training sample) may be obtained. The questionnaire may be provided in the application to obtain the first reference classification. Specifically, the first reference media item and a first reference question associated with the first reference media item may be provided to the first reference object in the application. The first reference classification is determined based on a first reference response submitted by the first reference object for the first reference question.

For the example in FIG. 1, the response submitted by the object may be determined, e.g., the object may interact with controls 132, . . . , and 134. Assuming that it is determined that the object presses the control 132 and clicks on the control 136, it may be determined that the corresponding response is “classification 1”. The reference sample may be constructed based on the determined classification, and the machine learning model 210 may be trained using a plurality of reference samples as collected. With some implementations of the disclosure, the questionnaire may be provided only to a small number of objects in the application (e.g., one thousandth of the quantity of objects in the application, or other proportion) to collect the classification. In this way, it can be ensured that most of the objects in the application can use the application normally. In the running process of the application, the questionnaire of respective object about the related questions of the provided media items and the response of respective object to the questionnaire may be collected.

According to some implementations of the disclosure, the first reference sample may further include object information of the first reference object and media information of the first reference media item. It should be understood that the object information may include contents in various aspects, for example, may include, but is not limited to, an identifier of the object, device information related to the object (for example, a type, a model and the like of the operating system), and the like. The media information may include contents in various aspects, for example, but not limited to, an identifier of the media item, a length of time of the media item, a content of the media item, and/or the like. The object information, the media information, and the reference classification may be mapped to a feature space, and an association relationship among these three may be learned by using the machine learning model 210.

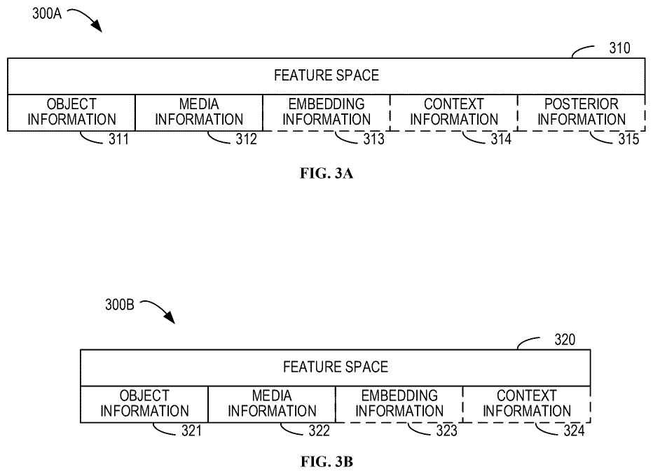

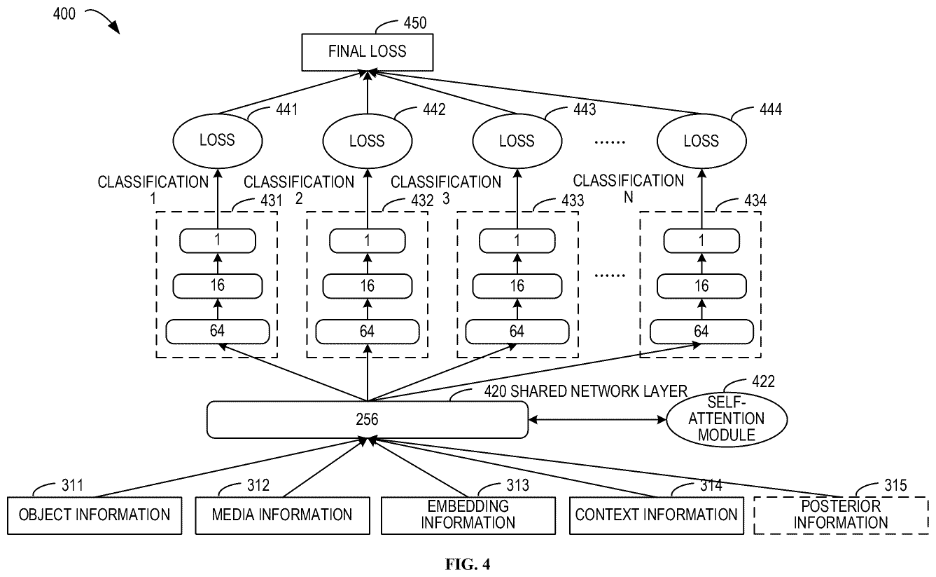

According to some implementations of the disclosure, the collected samples may be mapped to the feature space, and the first machine learning model and the second machine learning model may have different feature spaces. More information is provided below with reference to FIGS. 3A and 3B. FIG. 3A shows a block diagram 300A of a structure of a feature space of a first machine learning model according to some implementations of the disclosure. As shown in FIG. 3A, the feature space 310 may include features corresponding to object information 311 and media information 312, respectively. The collected object information 311 and media information 312 may be converted to corresponding object feature and media feature, respectively, using an encoder.

According to some implementations of the disclosure, the first sample may further include first additional information including at least any of: a first object embedding associated with the first reference object, a first media embedding associated with the first reference media item, first environment information associated with the first reference object and the first reference media item, and a first posterior label associated with the first reference classification. As shown in the dashed box portion in FIG. 3A, the feature space 310 may further include features corresponding to embedding information 313, context information 314, and a posterior label 315, respectively.

Here, the embedding information 313 may represent an object embedding of the related object and a media embedding of the related media determined using the encoder of the recommendation model. For example, the object embedding and the media embedding may be spliced directly in order to determine an embedding feature corresponding to the embedding information 313. The context information 314 may, for example, represent context information of the media item browsed by the object, such as a time point to start browsing, a length of time of browsing, a date of browsing, and the like. The context information 314 may be converted to a context feature using a corresponding encoder. The posterior information 315 may represent a posterior probability associated with the response submission of the object, and the posterior information 315 may be converted to a posterior feature using a corresponding encoder.

According to some implementations of the disclosure, the plurality of features may be spliced to generate a final feature for being input to the first machine learning model. With some implementations of the disclosure, factors that may affect classification may be described from multiple aspects, thereby improving the accuracy of the first machine learning model.

According to some implementations of the disclosure, the final feature described above may be input to the first machine learning model, and the first machine learning model may be updated. Specifically, in the process of determining the first machine learning model, a first prediction of the first reference classification may be determined by first machine learning model based on the object information of the first reference object and the media information of the first reference media item. The first machine learning model may be updated based on a first difference between the first reference classification and the first prediction.

Alternatively and/or additionally, the first additional information may be further considered.

Specifically, in the process of determining the first prediction of the first reference classification, the first prediction of the first reference classification may be further determined based on the first additional information by using the first machine learning model. In other words, the first prediction of the first reference classification may be determined based on the object information of the first reference object, the media information of the first reference media item, and the first additional information. With some implementations of the disclosure, knowledge about the classification may be obtained using a strong learning capability of the machine learning model based on historical data of whether a small number of objects submit a response.

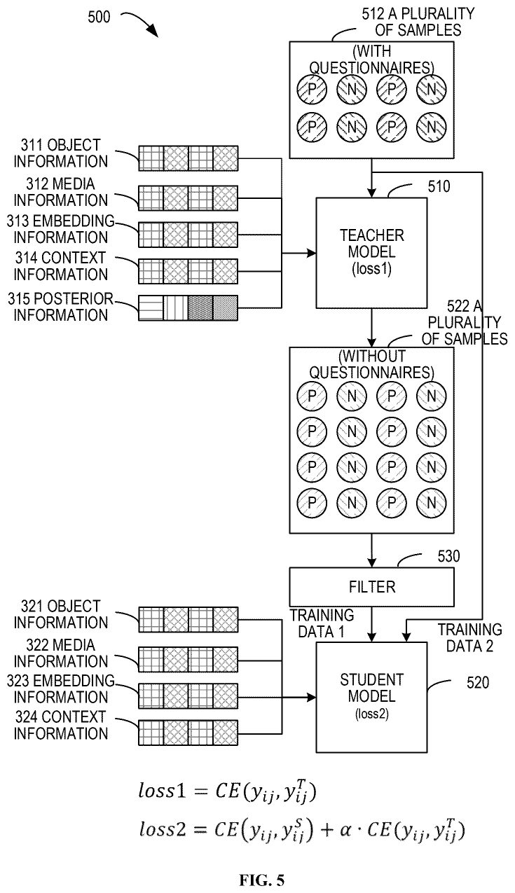

Referring to FIG. 4, a structure of a machine learning model is described, and FIG. 4 shows a block diagram 400 of a structure of a machine learning model according to some implementations of the disclosure. As shown in FIG. 4, the machine learning model may include a plurality of inputs for inputting the object information 311, the media information 312, the embedding information 313, the context information 314, and the posterior information 315. The above information may be encoded into features within the feature space, and input to a shared network layer 420. Here, a dimension of the shared network layer 420 may be, for example, 256, alternatively and/or additionally, a self-attention module 422 may be applied to the shared network layer 420.

The machine learning model may have branches corresponding to a plurality of classifications, respectively, e.g., a branch 431 corresponds to a classification 1, a branch 432 corresponds to a classification 2, a branch 433 corresponds to a classification 3, . . . , a branch 434 corresponds to a classification N. Here, the classification may represent a negative evaluation for the media item (e.g., undesirable classifications as follows: uninteresting, outdated, etc.). For example, the classification 1 may indicate that the media item belongs to an undesirable type 1, the classification 2 may indicate that the media item belongs to an undesirable type 2, and the like. It will be appreciated that most applications rely too much on the prediction model of the positive feedback, which often results in over-optimization of the short-term target while ignoring its long-term impact. For example, the user may show a short-term positive feedback for some fresh media items, but it may result in a decrease in recommendation accuracy if such videos occur frequently. According to some implementations of the disclosure, the recommendation model is adjusted through the negative feedback. In the running process of the application, the questionnaire may be proactively provided to fewer objects, and more comprehensive negative feedback may be collected. The machine learning model may be trained using the collected negative feedback and the output of the recommendation model may be adjusted using the machine learning model, thereby reducing the negative feedback.

As shown in FIG. 4, each branch may include a plurality of network layers, e.g., the branch 431 may include a plurality of network layers (which dimensions of 64, 16, and 1, respectively). Corresponding losses may be determined based on the outputs of the respective branches. For example, the feature may be input to the machine learning model and the prediction of the reference classification may be determined. The loss may be determined using a difference between a true value of the collected reference classification and the prediction of the reference classification. Each classification may correspond to a loss, e.g., the classification 1 corresponds to a loss 441, the classification 2 corresponds to a loss 442, the classification 3 corresponds to a loss 443, . . . , the classification N corresponds to a loss 444. Further, various losses may be weighted and summed to determine a final loss 450. It should be understood that although FIG. 4 shows N branches, alternatively and/or additionally, the machine learning model may include only one branch.

It should be understood that although the process of updating the first machine learning model is described above only with a single first reference object as an example. Alternatively and/or additionally, the first reference object may include a plurality of first reference objects. That is, the plurality of first reference objects may be objects that are provided with a questionnaire. According to some implementations of the disclosure, the first machine learning model may be trained by using a plurality of collected first reference samples, so that the first machine learning model may accurately represent an association relationship between a first object provided with a first media item and a first classification by the first object for the first media item. Alternatively and/or additionally, the prediction of the second reference classification by the second reference object in the application for the second reference media item may be determined using the first machine learning model. In this way, the first machine learning model may be utilized to generate more samples from the sparse samples to determine the second machine learning model.

According to some implementations of the disclosure, a second reference question associated with the second reference media item is not provided to the second reference object. In other words, the second reference object is an object in the application that is not provided with a questionnaire. According to some implementations of the disclosure, the second reference object includes a plurality of second reference objects, and a second number of the plurality of second reference objects is greater than a first number of the plurality of first reference objects. In this way, interference to normal use of the application may be reduced, and a large number of training samples may be obtained without providing a questionnaire to each object in the application.

Returning to FIG. 3B, more details regarding the second machine learning model are described, and FIG. 3B shows a block diagram 300B of a structure of a feature space of a second machine learning model according to some implementations of the disclosure. A feature space 320 of the second machine learning model may be similar to the feature space 310 of the first machine learning model. The difference is that since the questionnaire is not provided to the second reference object, the feature space 320 does not include posterior information. As shown in FIG. 3B, the feature space 320 may include an object feature corresponding to object information 321, and a media feature corresponding to media information 322, respectively.

According to some implementations of the disclosure, in the process of determining the prediction of the second reference classification using the first machine learning model, the prediction of the second reference classification may be determined by the first machine learning model based on second object information of the second reference object and second media information of the second reference media item. It should be understood that the prediction of the second reference classification may serve as a soft label in the training sample, and the second reference sample may be generated by using the second object information, the second media information, and the soft label, and the second machine learning model may be trained using the second reference sample.

According to some implementations of the disclosure, the second reference sample may further include second additional information including at least any of: a second object embedding associated with the second reference object, a second media embedding associated with the second reference media item, and second environment information associated with the second reference object and the second reference media item. As shown in FIG. 3B, the feature space 320 may further include embedding information 323, for example, representing object embedding of the related object and media embedding of the related media determined using the encoder of the recommendation model. For example, the object embedding and the media embedding may be spliced directly in order to determine an embedding feature corresponding to the embedding information 323.

According to some implementations of the disclosure, in the process of determining the prediction of the second reference classification, the prediction of the second reference classification may be determined by the first machine learning model based on the second additional information. In other words, the second object information, the second media information, and the second additional information may be input to the first machine learning model, so as to determine the prediction of the second reference classification in a more accurate manner. With some implementations of the disclosure, details of aspects in the additional information may be used to improve the accuracy of the prediction of the second reference classification, thereby providing more accurate training data for a subsequent training process. Further, the accuracy of the second machine learning model may be improved.

According to some implementations of the disclosure, in the process of determining the second machine learning model using the second reference sample, an additional prediction of the second classification may be determined by the second machine learning model based on the second object information and the second media information; and the second machine learning model may be updated based on a difference between the prediction of the second classification and the additional prediction of the second classification. It should be understood that, although the prediction of the second classification is not a truth label that is really collected, the prediction of the second classification is generated by using the trained first machine learning model, so that the second classification by the second object for the second media item may be accurately reflected to a certain extent. A corresponding loss function may be generated based on the difference, thereby updating the second machine learning model in a direction that minimizes the loss function.

According to some implementations of the disclosure, in the process of determining the additional prediction of the second classification, an additional prediction of the second reference classification may be determined by the second machine learning model based on the second additional information. In other words, the additional prediction of the second reference classification may be determined based on the object information 321, the media information 322, the embedding information 323, and the context information 324. In this way, more factors associated with the object and the media may be fully considered during determining the additional prediction, thereby improving the accuracy of the second machine learning model.

According to some implementations of the disclosure, the model of the second machine learning model may be similar to the structure shown in FIG. 4. The difference lies in that the data input to the second machine learning model does not include the posterior information 315 as indicated by the dotted box. Further, input information (e.g., inputting the object information 311, the media information 312, the embedding information 313, and the context information 314) for the first machine learning model at a plurality of input ends in FIG. 4 may be replaced with input information (e.g., inputting the object information 321, the media information 322, the embedding information 323, and the context information 324) for the second machine learning model. The second machine learning model may be trained in a similar manner, specifically, the final loss may be determined using the loss output at respective branches, and then the second machine learning model may be updated in a direction that minimizes the final loss.

A plurality of steps of determining the first machine learning model and the second machine learning model have been described, respectively, and the overall process of determining the second machine learning model is described below with reference to FIG. 5. According to some implementations of the disclosure, the machine learning model may be determined based on a knowledge distillation process. FIG. 5 shows a block diagram 500 of a process for managing a machine learning model based on distillation according to some implementations of the disclosure. As shown in FIG. 5, a teacher model 510 corresponds to the first machine learning model, and a student model 520 corresponds to the second machine learning model. Knowledge in the teacher model 510 may be transferred to the student model 520 based on the knowledge distillation process.

Specifically, a plurality of samples 512 representing samples determined via a questionnaire may be obtained. Specifically, the questionnaire may be provided to part of the objects (e.g., one thousandth, or other proportion) in the application, and the object is inquired about the classification of the media item that is just browsed. Here, the sample 512 may include a positive sample (denoted with P) and a negative sample (denoted by N). A feedback in the positive sample may be negative (e.g., the media item is considered to belong to a certain type of undesirable video), and a feedback in the negative sample may be positive (e.g., the media item is considered to not belong to a certain type of undesirable video).

The teacher model 510 may be trained using the object information 311, the media information 312, the embedding information 313, the context information 314, and the posterior information 315 associated with the plurality of samples 512. In the training process, the loss function may be defined according to Formula 1:

$$\\ \begin{matrix}loss 1 = CE ( {y}_{ij} , {y}_{ij}^{T} ) & Formula 1\end{matrix}$$

In Formula 1, i represents an ith object in the application, j representing a jth media item in the application, and

$$\\ {y}_{ij}^{T}$$

represents a classification by the ith object for the jth media item (from a truth data, and denoted with a superscript T). CE( ) represents a cross entropy loss. The teacher model 510 may be trained using the Formula 1 and using the sample 512 to obtain the trained teacher model 510.

A plurality of samples 522 may be generated using the teacher model 510, and the plurality of samples 522 may be obtained without providing a questionnaire to respective objects in the application. In other words, the teacher model 510 may be utilized to predict the classification by a certain object for a certain media item. In this way, soft labels for the plurality of samples may be determined, and corresponding positive and negative samples are generated. Then, a filter 530 may be used to filter the soft labels in the plurality of samples 522. It should be understood that the soft label indicates the probability that the object considers that the media item belongs to a negative classification, and thus a range is [0, 1]. Labels near 0 and labels near 1 may be filtered out of a large number of soft labels, and soft labels near intermediate values are ignored. Specifically, only soft labels in the range of [0, 0.2], [0.8, 1] may be reserved, and corresponding negative samples and positive samples may be generated. In this way, the accuracy of the training sample may be improved, thereby improving the accuracy of the machine learning model obtained by using the training sample.

Specifically, whether the soft label is used as the training data may be determined based on Formula 2 below.

$$\\ \begin{matrix}{g}_{ij} = \{ \begin{matrix}1 , if {y}_{ij}^{T} \leq t 1 or {y}_{ij}^{T} \geq t 2 \\ 0 , if others\end{matrix} & Formula 2\end{matrix}$$

According to some implementations of the disclosure, the student model 520 (corresponding to the second machine learning model) may be trained using the training data 1 output from the filter 530. For example, the student model 520 may be trained using the object information 321, the media information 322, the embedding information 323, and the context information 324 associated with the plurality of samples 522. In the training process, the loss function may be defined according to Formula 3:

$$\\ \begin{matrix}loss 2 = CE ( {y}_{ij} , {y}_{ij}^{S} ) & Formula 3\end{matrix}$$

In Formula 3, i represents an ith object in the application, j represents a jth media item in the application, and

$$\\ {y}_{ij}^{S}$$

represents a prediction of a classification by the ith object for the jth media item (a soft label, and denoted with a superscript S). CE( ) represents a cross entropy loss. The student model 520 may be trained using the Formula 2 and using the sample 522 to obtain the trained student model 520.

According to some implementations of the disclosure, the second machine learning model may be further updated by using the first reference sample. The loss function may be defined based on Formula 4. In Formula 4, the loss function for updating the student model may be determined based on the weighted summation of the loss shown in Formulas 1 and 3. For example, a may represent a weight for adjusting a proportion between two losses.

$$\\ \begin{matrix}loss 2 = CE ( {y}_{ij} , {y}_{ij}^{S} ) + α \cdot CE ( {y}_{ij} , {y}_{ij}^{T} ) & Formula 4\end{matrix}$$

According to some implementations of the disclosure, the media item may be recommended using the second machine learning model. For example, the prediction of the target classification by a target object for a target media item may be determined by the second machine learning model; and the target media item is provided to the target object based on the prediction of the target classification. Assuming that the media item is desired to be recommended to the object, the object information and the media information may be input to the second machine learning model, and a negative evaluation of the object for the media item is determined. The media item with lower negative evaluation may be preferentially recommended to the object.

Alternatively and/or additionally, the second machine learning model may be combined with an existing recommendation model. For example, an original recommendation index associated with the object and the media item may be determined by the recommendation model. Further, a final recommendation index may be determined based on the original recommendation index and the negative evaluation output by a recommendation prediction module, and then a certain media item is recommended to the object based on the final recommendation index. For example, the final recommendation index may be determined based on a weighted summation of the original recommendation index and the negative evaluation. With some implementations of the disclosure, in the process of recommending the media item, on one hand, a recommendation index determined based on an existing technical solution may be considered, and on the other hand, a negative evaluation determined based on a small quantity of questionnaires may be considered, so that the media item may be recommended to the object in a more accurate manner.

With some implementations of the disclosure, a small quantity of reference samples may be obtained with minimal interference or without interference on the usage of application. In this way, more reference samples may be obtained from the sparse reference samples, and the accuracy of the machine learning model is improved while reducing the interference on the normal use of the application.

### Example Process

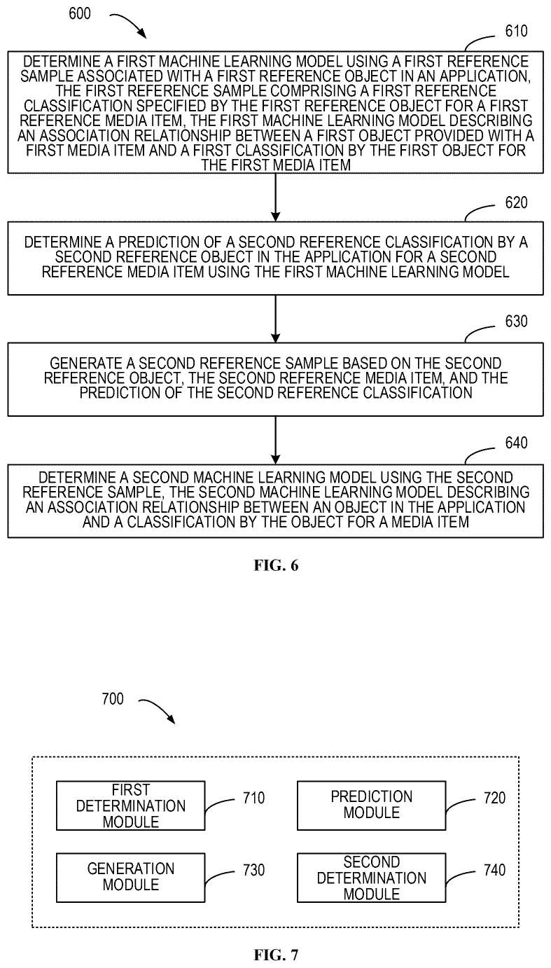

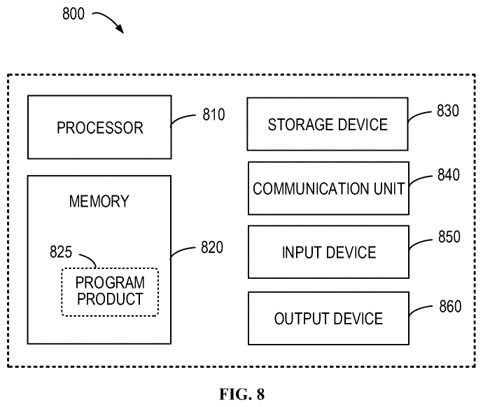

FIG. 6 shows a flowchart of a method 600 for managing a machine learning model according to some implementations of the disclosure. At block 610, a first machine learning model is determined using a first reference sample associated with a first reference object in an application, the first reference sample including a first reference classification specified by the first reference object for a first reference media item, the first machine learning model describing an association relationship between a first object provided with the first media item and a first classification by the first object for the first media item. At block 620, a prediction of a second reference classification by a second reference object in the application for a second reference media item is determined using the first machine learning model. At block 630, a second reference sample is generated based on the second reference object, the second reference media item, and the prediction of the second reference classification. At block 640, a second machine learning model is determined using the second reference sample, the second machine learning model describing an association relationship between an object in the application and a classification by the object for a media item.

According to some implementations of the disclosure, the first reference sample further includes object information of the first reference object and media information of the first reference media item, and determining the first machine learning model includes: determining a first prediction of the first reference classification by the first machine learning model based on the object information of the first reference object and the media information of the first reference media item; and updating the first machine learning model based on a first difference between the first reference classification and the first prediction.

According to some implementations of the disclosure, the first sample further includes first additional information including at least any of: a first object embedding associated with the first reference object, a first media embedding associated with the first reference media item, first environment information associated with the first reference object and the first reference media item, and a first posterior label associated with the first reference classification, and determining the first prediction of the first reference classification further includes: determining the first prediction of the first reference classification by the first machine learning model based on the first additional information.

According to some implementations of the disclosure, the first reference classification is obtained based on: providing to the first reference object in the application the first reference media item and a first reference question associated with the first reference media item; and determining the first reference classification based on a first reference response submitted by the first reference object for the first reference question.

According to some implementations of the disclosure, determining the prediction of the second reference classification using the first machine learning model includes: determining the prediction of the second reference classification by the first machine learning model based on second object information of the second reference object and second media information of the second reference media item.

According to some implementations of the disclosure, the second reference sample further includes second additional information including at least any of: a second object embedding associated with the second reference object, a second media embedding associated with the second reference media item, and second environment information associated with the second reference object and the second reference media item, and determining the prediction of the second reference classification further includes determining the prediction of the second reference classification by the first machine learning model based on the second additional information.

According to some implementations of the disclosure, determining the second machine learning model using the second reference sample includes: determining an additional prediction of the second classification by the second machine learning model based on the second object information and the second media information; and updating the second machine learning model based on a difference between the prediction of the second classification and the additional prediction of the second classification.

According to some implementations of the disclosure, determining the second machine learning model using the second reference sample further includes: updating the second machine learning model using the first reference sample.

According to some implementations of the disclosure, the second reference sample further includes second additional information including at least any of: a second object embedding associated with the second reference object, a second media embedding associated with the second reference media item, and second environment information associated with the second reference object and the second reference media item, and determining the additional prediction of the second classification further includes: determining the additional prediction of the second reference classification by the second machine learning model based on the second additional information.

According to some implementations of the disclosure, the first reference object includes a plurality of first reference objects, the second reference object includes a plurality of second reference objects, and a second number of the plurality of second reference objects is greater than a first number of the plurality of first reference objects.

According to some implementations of the disclosure, a second reference question associated with the second reference media item is not provided to the second reference object, and the classification represents a negative evaluation for the media item.

According to some implementations of the disclosure, the method further includes: determining a prediction of a target classification by the target object for a target media item via the second machine learning model; and providing the target media item to the target object based on the prediction of the target classification.

### Example Apparatus and Device

FIG. 7 shows a block diagram of an apparatus 700 for managing a machine learning model according to some implementations of the disclosure. The apparatus 700 includes: a first determination module configured to determine a first machine learning model using a first reference sample associated with a first reference object in an application, the first reference sample including a first reference classification specified by the first reference object for a first reference media item, the first machine learning model describing an association relationship between a first object provided with a first media item and a first classification by the first object for the first media item; a prediction module configured to determine a prediction of a second reference classification by the second reference object in the application for a second reference media item using the first machine learning model; a generation module configured to generate a second reference sample based on the second reference object, the second reference media item, and the prediction of the second reference classification; and a second determination module configured to determine a second machine learning model using the second reference sample, the second machine learning model describing an association relationship between an object in the application and a classification by the object for a media item.

According to some implementations of the disclosure, the first reference sample further includes object information of the first reference object and media information of the first reference media item, and the first determination module is further configured to: determine a first prediction of the first reference classification by the first machine learning model based on the object information of the first reference object and the media information of the first reference media item; and update the first machine learning model based on a first difference between the first reference classification and the first prediction.

According to some implementations of the disclosure, the first sample further includes first additional information, the first additional information includes at least any of: a first object embedding associated with the first reference object, a first media embedding associated with the first reference media item, first environment information associated with the first reference object and the first reference media item, and a first posterior label associated with the first reference classification, and the first determination module is further configured to determine the first prediction of the first reference classification by the first machine learning model based on the first additional information.

According to some implementations of the disclosure, the first reference classification is obtained based on: providing to the first reference object in the application the first reference media item and a first reference question associated with the first reference media item; and determining the first reference classification based on a first reference response submitted by the first reference object for the first reference question.

According to some implementations of the disclosure, the prediction module is further configured to: determine the prediction of the second reference classification by the first machine learning model based on second object information of the second reference object and second media information of the second reference media item.

According to some implementations of the disclosure, the second reference sample further includes second additional information, the second additional information includes at least any of: a second object embedding associated with the second reference object, a second media embedding associated with the second reference media item, and second environment information associated with the second reference object and the second reference media item, and the prediction module is further configured to: determine the prediction of the second reference classification by the first machine learning model based on the second additional information.

According to some implementations of the disclosure, the second determination module is further configured to: determine an additional prediction of the second classification by the second machine learning model based on the second object information and the second media information; and update the second machine learning model based on a difference between the prediction of the second classification and the additional prediction of the second classification.

According to some implementations of the disclosure, the second determination module is further configured to update the second machine learning model using the first reference sample.

According to some implementations of the disclosure, the second reference sample further includes second additional information, the second additional information includes at least any of: a second object embedding associated with the second reference object, a second media embedding associated with the second reference media item, and second environment information associated with the second reference object and the second reference media item, and the second determination module is further configured to: determine the additional prediction of the second reference classification by the second machine learning model based on the second additional information.

According to some implementations of the disclosure, the first reference object includes a plurality of first reference objects, the second reference object includes a plurality of second reference objects, and a second quantity of the plurality of second reference objects is greater than a first number of the plurality of first reference objects.

According to some implementations of the disclosure, a second reference question associated with the second reference media item is not provided to the second reference object, and the classification represents a negative evaluation for the media item.

According to some implementations of the disclosure, the apparatus further includes a processing module configured to: determine a prediction of a target classification by a target object for a target media item via the second machine learning model; and provide the target media item to the target object based on the prediction of the target classification.

FIG. 7 shows a block diagram of a device 700 capable of implementing various implementations of the disclosure. It should be understood that a computing device 700 shown in FIG. 7 is merely illustrative and should not constitute any limitation on the functionality and scope of the implementations described herein. The computing device 700 shown in FIG. 7 may be configured to implement the method described above.

As shown in FIG. 7, the computing device 700 is in a form of a general-purpose computing device. Components of the computing device 700 may include, but are not limited to, one or more processors or processing units 710, a memory 720, a storage device 730, one or more communication units 740, one or more input devices 750, and one or more output devices 760. The processor 710 may be an actual or virtual processor and capable of performing various processes according to programs stored in the memory 720. Ina multiprocessor system, the plurality of processors execute computer-executable instructions in parallel to improve the parallel processing capability of the computing device 700.

The computing device 700 generally includes a plurality of computer storage media. Such media may be any available media accessible by the computing device 700, including, but not limited to, volatile and non-volatile media, removable and non-removable media. The memory 720 may be volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 730 may be a removable or non-removable medium and may include a machine-readable medium, such as a flash drive, a magnetic disk, or any other medium, which may be capable of storing information and/or data (e.g., training data for training) and may be accessed within the computing device 700.

The computing device 700 may further include additional removable/non-removable, volatile/non-volatile storage media/medium. Although not shown in FIG. 7, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 720 may include a computer program product 725 having one or more program modules configured to perform various methods or actions of various implementations of the disclosure.

The communications unit 740 implements communication with other computing devices through a communications medium. Additionally, the functionality of components of the computing device 700 may be implemented in a single computing cluster or multiple computing machines capable of communicating over a communication connection. Thus, the computing device 700 may operate in a networked environment using logical connection(s) with one or more other servers, a network personal computer (PC), or another network node.

The input device 750 may be one or more input devices, such as a mouse, a keyboard, a trackball, or the like. The output device 760 may be one or more output devices, such as a display, a speaker, a printer, or the like. The computing device 700 may also communicate with one or more external devices (not shown) through the communication unit 740 as needed, the external device such as a storage device, a display device, etc., communicates with one or more devices that enable a user to interact with the computing device 700, or communicates with any device (e.g., a network card, a modem, etc.) that enables the computing device 700 to communicate with one or more other computing devices. Such communication may be performed via an input/output (I/O) interface (not shown).

According to an implementation of the disclosure, there is provided a computer-readable storage medium having computer-executable instructions stored thereon, and the computer-executable instructions are executed by a processor to implement the method described above. According to an implementation of the disclosure, a computer program product is further provided, the computer program product being tangibly stored on a non-transitory computer-readable medium and including computer-executable instructions, the computer-executable instructions being executed by a processor to implement the method described above. According to an implementation of the disclosure, there is provided a computer program product having stored thereon a computer program, which, when executed by a processor, implements the method described above.

Aspects of the disclosure are described herein with reference to flowcharts and/or block diagrams of a method, an apparatus, a device, and a computer program product implemented in accordance with the disclosure. It should be understood that each block of the flowchart and/or block diagram, and combination(s) of blocks in the flowchart(s) and/or block diagram(s), may be implemented by computer readable program instructions.

These computer-readable program instructions may be provided to a processing unit of a general purpose computer, special purpose computer, or other programmable data processing apparatus to produce a machine, such that the instructions, when executed by a processing unit of the computer or other programmable data processing apparatus, produce means to implement the functions/acts specified in one or more blocks in the flowchart(s) and/or block diagram(s). These computer-readable program instructions may also be stored in a computer-readable storage medium, and cause the computer, programmable data processing apparatus, and/or other devices to work in a particular manner, such that the computer-readable medium storing instructions includes an article of manufacture including instructions to implement aspects of the functions/acts specified in one or more blocks in the flowchart(s) and/or block diagram(s).

The computer-readable program instructions may be loaded onto the computer, other programmable data processing apparatus, or other apparatus, such that a series of operational steps are performed on the computer, other programmable data processing apparatus, or other apparatus to produce a computer-implemented process, such that the instructions executed on the computer, other programmable data processing apparatus, or other apparatus implement the functions/acts specified in one or more blocks in the flowchart(s) and/or block diagram(s).

The flowcharts and block diagrams in the figures show architecture, functionality, and operation that may be possibly implemented by system(s), method(s), and computer program product(s) according to various implementations of the disclosure. In this regard, each block in the flowchart or block diagram may represent a module, program segment, or part of an instruction that includes one or more executable instructions for implementing the specified logical function. In some alternative implementations, the functions noted in the block(s) may also occur in a different order than noted in the figures. For example, two consecutive blocks may actually be performed substantially in parallel, which may sometimes be performed in the reverse order, depending on the functionality involved. It is also noted that each block in the block diagram and/or flowchart, as well as combination(s) of blocks in the block diagram(s) and/or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for managing a machine learning model, comprising:
determining a first machine learning model using a first reference sample associated with a first reference object in an application, the first reference sample comprising a first reference classification specified by the first reference object for a first reference media item, the first machine learning model describing an association relationship between a first object provided with a first media item and a first classification by the first object for the first media item;
determining a prediction of a second reference classification by a second reference object in the application for a second reference media item using the first machine learning model;
generating a second reference sample based on the second reference object, the second reference media item, and the prediction of the second reference classification; and
determining a second machine learning model using the second reference sample, the second machine learning model describing an association relationship between an object in the application and a classification by the object for a media item.

2. The method of claim 1, wherein the first reference sample further comprises object information of the first reference object and media information of the first reference media item, and determining the first machine learning model comprises:
determining a first prediction of the first reference classification by the first machine learning model based on the object information of the first reference object and the media information of the first reference media item; and
updating the first machine learning model based on a first difference between the first reference classification and the first prediction.

3. The method of claim 2, wherein the first sample further comprises first additional information comprising at least any of: a first object embedding associated with the first reference object, a first media embedding associated with the first reference media item, first environment information associated with the first reference object and the first reference media item, and a first posterior label associated with the first reference classification, and
determining the first prediction of the first reference classification further comprises: determining the first prediction of the first reference classification by the first machine learning model based on the first additional information.

4. The method of claim 1, wherein the first reference classification is obtained based on:
providing to the first reference object in the application the first reference media item and a first reference question associated with the first reference media item; and
determining the first reference classification based on a first reference response submitted by the first reference object for the first reference question.

5. The method of claim 1, wherein determining the prediction of the second reference classification using the first machine learning model comprises:
determining the prediction of the second reference classification by the first machine learning model based on second object information of the second reference object and second media information of the second reference media item.

6. The method of claim 5, wherein the second reference sample further comprises second additional information comprising at least any of: a second object embedding associated with the second reference object, a second media embedding associated with the second reference media item, and second environment information associated with the second reference object and the second reference media item, and
determining the prediction of the second reference classification further comprises: determining the prediction of the second reference classification by the first machine learning model based on the second additional information.

7. The method of claim 6, wherein determining the second machine learning model using the second reference sample comprises:
determining an additional prediction of the second classification by the second machine learning model based on the second object information and the second media information; and
updating the second machine learning model based on a difference between the prediction of the second classification and the additional prediction of the second classification.

8. The method of claim 1, wherein determining the second machine learning model using the second reference sample further comprises:
updating the second machine learning model using the first reference sample.

9. The method of claim 7, wherein the second reference sample further comprises second additional information comprising at least any of: a second object embedding associated with the second reference object, a second media embedding associated with the second reference media item, and second environment information associated with the second reference object and the second reference media item, and
determining the additional prediction of the second classification further comprises: determining the additional prediction of the second reference classification by the second machine learning model based on the second additional information.

10. The method of claim 1, wherein the first reference object comprises a plurality of first reference objects, the second reference object comprises a plurality of second reference objects, and a second number of the plurality of second reference objects is greater than a first number of the plurality of first reference objects.

11. The method of claim 1, wherein a second reference question associated with the second reference media item is not provided to the second reference object, and the classification represents a negative evaluation for the media item.

12. The method of claim 1, further comprising:
determining a prediction of a target classification by a target object for a target media item via the second machine learning model; and
providing the target media item to the target object based on the prediction of the target classification.

13. An electronic device, comprising:
at least one processor; and
at least one memory coupled to the at least one processor and storing instructions for execution by the at least one processor, the instructions, when executed by the at least one processor, causing the electronic device to perform acts comprising:
determining a first machine learning model using a first reference sample associated with a first reference object in an application, the first reference sample comprising a first reference classification specified by the first reference object for a first reference media item, the first machine learning model describing an association relationship between a first object provided with a first media item and a first classification by the first object for the first media item;
determining a prediction of a second reference classification by a second reference object in the application for a second reference media item using the first machine learning model;
generating a second reference sample based on the second reference object, the second reference media item, and the prediction of the second reference classification; and
determining a second machine learning model using the second reference sample, the second machine learning model describing an association relationship between an object in the application and a classification by the object for a media item.

14. The electronic device of claim 13, wherein the first reference sample further comprises object information of the first reference object and media information of the first reference media item, and determining the first machine learning model comprises:
determining a first prediction of the first reference classification by the first machine learning model based on the object information of the first reference object and the media information of the first reference media item; and
updating the first machine learning model based on a first difference between the first reference classification and the first prediction.

15. The electronic device of claim 13, wherein the first reference classification is obtained based on:
providing to the first reference object in the application the first reference media item and a first reference question associated with the first reference media item; and
determining the first reference classification based on a first reference response submitted by the first reference object for the first reference question.

16. The electronic device of claim 13, wherein determining the prediction of the second reference classification using the first machine learning model comprises:
determining the prediction of the second reference classification by the first machine learning model based on second object information of the second reference object and second media information of the second reference media item.

17. The electronic device of claim 13, wherein determining the second machine learning model using the second reference sample further comprises:
updating the second machine learning model using the first reference sample.

18. The electronic device of claim 13, wherein the first reference object comprises a plurality of first reference objects, the second reference object comprises a plurality of second reference objects, and a second number of the plurality of second reference objects is greater than a first number of the plurality of first reference objects.

19. The electronic device of claim 13, wherein the acts further comprises:
determining a prediction of a target classification by a target object for a target media item via the second machine learning model; and
providing the target media item to the target object based on the prediction of the target classification.

20. A non-transitory computer-readable storage medium having stored thereon computer instructions that, when executed by a processor, cause the processor to perform acts comprising:
determining a first machine learning model using a first reference sample associated with a first reference object in an application, the first reference sample comprising a first reference classification specified by the first reference object for a first reference media item, the first machine learning model describing an association relationship between a first object provided with a first media item and a first classification by the first object for the first media item;
determining a prediction of a second reference classification by a second reference object in the application for a second reference media item using the first machine learning model;
generating a second reference sample based on the second reference object, the second reference media item, and the prediction of the second reference classification; and
determining a second machine learning model using the second reference sample, the second machine learning model describing an association relationship between an object in the application and a classification by the object for a media item.
